(19) United States
(12) Patent Application Publication
(10) Pub. No.: US 2018/0313317 A1
(43) Pub. Date: Nov. 1, 2018

(54) IGNITION PLUG AND IGNITION DEVICE

(71) Applicant: IMAGINEERING, INC., Kobe (JP)

(72) Inventors: Yuji IKEDA, Kobe (JP); Seiji KANBARA, Kobe (JP); Atsushi NISHIYAMA, Kobe (JP); Keisuke TAKEMOTO, Kobe (TW); Shoushi WATANABE, Kobe (JP)

(21) Appl. No.: 15/772,303

(22) PCT Filed: Oct. 26, 2016
(86) PCT No.: PCT/JP2016/082148

§ 371 Date: Apr. 30, 2018

(30) Foreign Application Priority Data
Oct. 30, 2015 (JP) 2015-214431

(51) Int. Cl. F02P 3/01; F02P 23/04; F02P 13/00; H01T 13/20; H01T 13/50

(52) U.S. Cl. CPC F02P 3/01; F02P 23/04; H01T 13/50; H01T 13/20; F02P 13/00

(57) ABSTRACT

An erosion of an electrode is prevented in a spark plug that performs an ignition by use of a spark discharge and an electromagnetic wave. The spark plug that a pulse voltage for a spark discharge and an electromagnetic wave supplied into the spark discharge as an energy are applied to a center electrode, the spark plug comprises the center electrode, an insulator including an axis hole into which the center electrode is engaged, a ground electrode configured to form a space between the ground electrode and the center electrode in which the spark discharge is generated, and a cylindrical conductor that is arranged at an outer circumference of the insulator, and an annular member is formed at an inner circumference of the cylindrical conductor and at a position where a distance from a distal end surface of the cylindrical conductor is within a range between ⅛ wavelength and ¼ wavelength of the electromagnetic wave.

### TECHNICAL FIELD

The present invention relates to a spark plug which a pulse voltage for a spark discharge and an electromagnetic wave supplied into the spark discharge as an energy are applied to a center electrode.

### BACKGROUND ART

The spark plug that produces a local plasma by use of the discharge of the spark plug and expands the plasma by use of the electromagnetic wave such as microwave, has been developed for a long time (for example, Patent Document 1 by the applicant of the present application). The mixing circuit that mixes the high voltage pulse for the spark discharge and energy of the microwave emitted from the microwave oscillator is arranged in the spark plug of Patent Document 1, and the mixing circuit is connected to the input terminal of the spark plug. The high voltage pulse for the spark discharge passes through the inside of the center electrode so as to lead to the discharge electrode of the spark plug, and the spark discharge is generated between the discharge electrode and the ground electrode. On the other hand, the microwave is led to the distal end of the spark plug by passing on the outer surface of the center electrode, and thereby, the microwave is emitted from the distal end thereof. Since the ignition is performed by use of both the spark discharge and the microwave according to the spark plug, the stronger ignition performance compared to the conventional art is enabled and the combustion efficiency can be enhanced.

### PRIOR ART DOCUMENTS

### Patent Document(s)

Patent Document 1: Japanese unexamined patent application publication No. 2009-036198

### SUMMARY OF INVENTION

### Problem to be Solved by Invention

However, the plasma energy generated by use of the spark discharge and the microwave is too large and the plasma becomes the thermal plasma according to the spark plug of the Patent Document 1, and as a result, there is a case where the discharge electrode and etc. is worn away by heat. The present invention is made from the above viewpoints.

### Means for Solving the Above Problems

A spark plug in which a pulse voltage for a spark discharge and an electromagnetic wave supplied into the spark discharge as an energy are applied to a center electrode, the spark plug comprises the center electrode, an insulator including an axis hole into which the center electrode is engaged, a ground electrode configured to form a space between the ground electrode and the center electrode in which the spark discharge is generated, and a cylindrical conductor that is arranged at an outer circumference of the insulator, an annular member is formed at an inner circumference of the cylindrical conductor, and formed at a position where a distance from a distal end surface of the cylindrical conductor is within a range between ⅛ wavelength and ¼ wavelength of the electromagnetic wave.

An spark system including the spark plug, the spark system comprises a controller configured to occur the spark discharge at a first space between the center electrode and the ground electrode by supplying the pulse voltage into the center electrode so as to generate a plasma at the first space, and expand the plasma at the first space by supplying the electromagnetic wave into the center electrode, and the spark plug is formed such that at least a part of the electromagnetic wave reflected at the plasma formed at the first space of the electromagnetic wave emitted into the first space from a distal end of the center electrode, is entered into a protruding part of the annular member via the cylindrical conductor when the electromagnetic wave is supplied into the center electrode after forming the plasma at the first space.

### Effect of Invention

According to the present invention, an erosion of an electrode can be prevented in a spark plug that performs an ignition by use of a spark discharge and an electromagnetic wave.

### BRIEF DESCRIPTION OF FIGURES

FIG. 1 shows a front view of a partial cross section of a spark plug regarding the present embodiment.

### EMBODIMENTS FOR IMPLEMENTING THE INVENTION

In below, embodiments of the present invention are described in details based on figures. Note that, following embodiments are essentially preferable examples, and the scope of the present invention, the application, or the use is not intended to be limited.

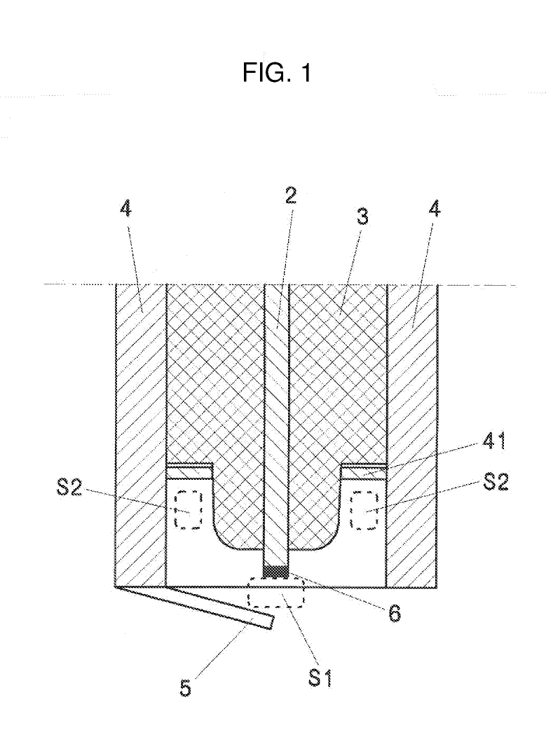

Referring to FIG. 1, a spark plug 1 of the present embodiment comprises a center electrode 2, an insulator 3, a metal fitting 4, and a ground electrode 5. The center electrode 2 is a cylindrical type conductor, made of an iron nickel for example, and a pulse voltage is transmitted thereinside, while a microwave is transmitted on an outer surface thereof. The pulse voltage is generated by an ignition coil (not illustrated), and this is inputted to the center electrode 2 from a terminal part (not illustrated) of the spark plug 1. On the other hand, the microwave is generated at an outside microwave oscillator (not illustrated), and similar to the above, the microwave is inputted to the center electrode 2 from the terminal part.

The insulator 3 is a cylindrical type insulator (made of ceramic for example), and an axis hole into which the center electrode 2 is engaged, is formed thereinside. The metal fitting 4 is made of a cylindrical metal conductor that is formed so as to surround the insulator 3. A female screw (not illustrated) that is engaged into a spark-plug-mounting-hole of a cylinder head of an internal combustion engine, is arranged at an outer circumferential part of the metal fitting 4. A discharge electrode 6 is jointed on the distal end of the center electrode 2. One end of the ground electrode 5 is jointed to the distal end of the metal fitting 4, and the other end thereof opposes to the discharge electrode 6.

The outer circumferential surface at the distal end side of the insulator 3 is separated in a distance from the inner circumferential surface of the metal fitting 4. An annular protruding member 41 is formed at a position where a distance of about from ⅛ wavelength to ¼ wavelength of microwave is separated from the distal end surface of the metal fitting 4 at the inner circumference thereof (In below, unless otherwise noted, simply referred to “wavelength” indicates an inputted microwave wavelength). The spark plug 1 realizes an effect of an erosion prevention of the distal end of the center electrode 2 (discharger) by forming the protruding member 41. The reason is explained in below.

The plasma is generated in a space S1 between the center electrode 2 and the ground electrode 5 at the spark plug 1 by performing the spark discharge at the space S1 firstly. Secondly, the plasma of the space S1 is expanded by emitting the microwave into the space S1 from the outer circumference distal end of the center electrode 2. Ideally, all the microwave emitted into the space S1 is absorbed by the plasma; however, if the plasma density is too high, a part of the microwave is reflected without being absorbed into the plasma. The microwave reflected at the plasma is turned back to the rear end (supply part) via the center electrode 2, the metal fitting 4, and the insulator 3, and then becomes unnecessary electric power. Moreover, there is a negative effect that the plasma generated at the space S1 becomes the thermal plasma, and the distal end of the center electrode 2 suffers under the influence of erosion.

On the other hand, an annular type protruding member 41 is arranged at the inner circumferential surface of the metal fitting 4 in the spark plug 1 of the present invention. The protruding member 41 functions as a kind of stub tuner, and prevents the microwave from flowing reversely into the supply side. A part of microwave entered into the protruding member 41 again transmits into the distal end side, and the part of microwave entered into the protruding member 41 and the microwave flowing reversely from the distal end surface of the metal fitting 4 are cancelling from each other. As a result, the microwave reflected at the plasma of the space S1 can be prevented from flowing reversely into the supply side.

Note that, it is ideally preferable that the protruding member 41 is arranged at a position of ¼ wavelength of the microwave in a distance starting from the distal end surface of the metal fitting 4 based on the principle of the stub tuner. Note that, since the insulator 3 is arranged at the inner circumference of the distal end side of the metal fitting 4, it can be considered to be desirable that the protruding member 41 is arranged at a position shorter in length than ¼ wavelength in fact. Note that, when the protruding member 41 is arranged at a position of ⅛ wavelength of microwave in distance from the distal end surface of the metal fitting 4, it does not function as the stub tuner, and therefore, it is desirable that the protruding member 41 is arranged at a position greater than or equal to ⅛ wavelength of microwave in distance starting from the distal end surface of the metal fitting 4.

Moreover, an entrance of microwave into the protruding member 41 is triggered, and the plasma at the space S1 is induced into an annular space S2 that is surrounded by the protruding member 41, the insulator 3, and the metal fitting 4. Thereby, too much enlarging of the plasma density of the space S1 can be suppressed, and the plasma of the space S1 is prevented from becoming the thermal plasma.

With regard to this point, if the protruding member 41 is arranged at a position in distance no more than ⅛ wavelength from the distal end surface of the metal fitting 4, the distance between the space S1 and the space S2 is too short, and therefore, an excess increase of the plasma density at the space S1 cannot be suppressed. On the other hand, when the protruding member 41 is arranged at a position of ¼ wavelength of microwave over in distance from the distal end surface of the metal fitting 4, there is a case where a shape of the distal end of the insulator 3 is required to change. That is because the length separated from the metal fitting 4 to a part at the distal end side of the insulator 3 is no more than ¼ wavelength in many cases of the normal spark plug.

As above, the embodiment of the present invention is explained. The scope of the present invention is absolutely defined based on the invention claimed in the claim, and is not limited into the above embodiment.

The microwave is illustrated as an example of an electromagnetic wave; however, the electromagnetic wave may be an electromagnetic wave having other wavelength band. Moreover, the metal fitting 4 is an example of the cylindrical conductor of the present invention; however, a cylindrical conductor for only microwave-return-line use, for example, may be arranged.

### NUMERAL SYMBOLS EXPLANATION

1. Spark Plug
2. Center Electrode
3. Insulator
4. Metal Fitting
5. Ground Electrode
6. Discharge Electrode

1-5. (canceled)

6. A spark plug in which a pulse voltage for a spark discharge and an electromagnetic wave supplied into the spark discharge as an energy are applied to a center electrode, the spark plug comprising:
the center electrode;
an insulator including an axis hole into which the center electrode is engaged;
a ground electrode configured to form a space between the ground electrode and the center electrode in which the spark discharge is generated; and
a cylindrical conductor that is arranged at an outer circumference of the insulator,
wherein an annular member is formed at an inner circumference of the cylindrical conductor, and formed at a position where a distance from a distal end surface of the cylindrical conductor is within a range between ⅛ wavelength and ¼ wavelength of the electromagnetic wave.

7. The spark plug according to claim 6, wherein the cylindrical conductor is a metal fitting.

8. The spark plug according to claim 6, wherein an inner circumferential surface of the cylindrical conductor contacts with an outer circumference surface of the insulator.

9. A spark system including the spark plug according to claim 6,
the spark system comprising:
a controller configured to occur the spark discharge at a first space between the center electrode and the ground electrode by supplying the pulse voltage into the center electrode so as to generate a plasma at the first space, and expand the plasma at the first space by supplying the electromagnetic wave into the center electrode,
wherein
the spark plug is formed such that at least a part of the electromagnetic wave reflected at the plasma formed at the first space of the electromagnetic wave emitted into the first space from a distal end of the center electrode, is entered into a protruding part of the annular member via the cylindrical conductor when the electromagnetic wave is supplied into the center electrode after forming the plasma at the first space.

10. The spark system according to claim 9, wherein at least a part of the plasma formed at the first space is moved to a second space, the second space being a space formed between the distal end of the cylindrical conductor and the outer circumference of the insulator,
whereby the plasma at the first space is prevented from becoming thermal plasma when the electromagnetic wave is entered into the protruding part of the annular member.
